(19) United States
(12) Patent Application Publication
(10) Pub. No.: US 2009/0023056 A1
(43) Pub. Date: Jan. 22, 2009

(54) BATTERY PACK THERMAL MANAGEMENT SYSTEM

(75) Inventors: Daniel T. Adams, Palo Alto, CA (US); Gene Berdichevsky, Palo Alto, CA (US); Thomas Everett Colson, Sunnyvale, CA (US); Arthur Hebert, San Carlos, CA (US); Scott Kohn, Menlo Park, CA (US); David Lyons, Palo Alto, CA (US); Noel Jason Mendez, Mountain View, CA (US); Jeffrey Brian Straubel, Menlo Park, CA (US); Dorian West, Menlo Park, CA (US); Andrew Simpson, San Carlos, CA (US)

Correspondence Address: RAGGIO & DINNIN, P.C., 2701 CAMBRIDGE COURT, STE. 410, AUBURN HILLS, MI, 48326, US

(73) Assignee: TESLA MOTORS, INC., San Carlos, CA (US)

(21) Appl. No.: 11/779,583

(22) Filed: Jul. 18, 2007

(51) Int. Cl. H01M 10/50; B23P 15/26; H01M 2/00; B60H 1/32

(52) U.S. Cl. 429/120; 180/60; 29/890.035; 429/90; 62/243

(57) ABSTRACT

A battery pack thermal management system for use in an electric car. The battery pack thermal management system includes a plurality of thermistors connected to a plurality of cells of a battery pack. A battery monitor board is connected to the thermistors. The system also includes a manifold and a plurality of cooling tubes connected to the manifold. A tube seal plug is arranged over an end of the cooling tube and an end fitting is arranged on an end of the cooling tube. The thermal management system will cool the battery pack to predetermined temperatures to increase the longevity of the battery pack within the electric vehicle.

### BACKGROUND OF THE INVENTION

1. Field of the Invention

The subject invention generally relates to a thermal management system and more particularly relates to a battery pack thermal management system for use in an electric vehicle.

2. Description of Related Art

It is well known in the prior art to use all electric automobiles to provide transportation for occupants. Many of these prior art electric automobiles carry several thousand pounds of nickel metal hydride batteries to achieve a long range electric vehicle for every day use by consumers. Furthermore, many of these prior art electrical cars need to be physically large and heavy to accommodate all of these batteries, such that these cars were not capable of achieving necessary acceleration, handling, performance and the extended range needed for an electric car to become a feasible option for public purchase and use. Many prior art electrical cars that were of normal size and not overly heavy would have a very small range, thus reducing the feasibility for large mass selling of such cars to the consuming public. Furthermore, many of these prior art electrical cars which use such batteries had problems with protecting the occupants in the vehicle from the high voltage components and high temperatures that emanated from such high voltage components and still provide a car that moved at acceptable speeds comparable to that of a gasoline or diesel internal combustion engine-equipped vehicle. Many of these prior art electrical cars have had problems with the prior art batteries overheating, thus reducing the range of the electric car and the durability and overall life of the batteries or cells that are part of the battery pack systems within the electric vehicle.

Generally, the batteries or cells arranged within many prior art vehicles operate with high power output which increases the temperature and hence may reduce the longevity of the prior art batteries. The use of the heavy and high voltage battery systems in prior art electrical cars requires a lot of maintenance to keep the batteries operating due to the high temperatures at which the battery pack systems operated. Some of these prior art systems tried to maximize the longevity of their batteries by using air cooled systems that would blow cooled air over the batteries to try and remove heat from the battery compartment and batteries in these prior art electrical vehicles. However, many of these prior art heat reduction systems for the batteries were not very efficient and did not provide an efficient system for thermally balancing the batteries. Hence, the prior art system may suffer from overheating or over cooling thus reducing the durability and longevity of the batteries and hence, the range of the electric vehicle. Generally, in these prior art vehicles if the batteries got too hot it would reduce the batteries longevity and ability to hold a charge, thus reducing the range of the electric vehicle and the overall feasibility for selling such electric cars to the consuming public.

Therefore, there is a need in the art for an improved battery pack thermal management system for use in an electric vehicle. There also is a need in the art for a methodology and system that will maximize the longevity and performance of a battery pack by having precise thermal management of the battery pack. There also is a need in the prior art for a thermal management system that will thermally connect each of the cells in a battery pack thereby thermally balancing the overall battery pack system. There also is a need in the art for a thermal management system that will increase the maximum longevity, efficiency and power that can be extracted from the batteries thus increasing the range and performance of the electric car for the consumer. There also is a need in the art for a battery pack thermal management system that is capable of removing heat from the battery pack such as to cool or chill the battery pack and a thermal management system that is capable of heating the battery pack if the battery pack system so requires.

### SUMMARY OF THE INVENTION

One object of the present invention may be to provide an improved battery pack thermal management system.

Another object of the present invention may be to provide a thermal management system for use in an electric vehicle.

Still another object of the present invention may be to provide a thermal management system that will maximize the longevity, efficiency and power extracted from an energy storage system.

Still another object of the present invention may be to provide a thermal management system that thermally connects each cell of the energy storage system thus reducing the thermal impedance between the cells.

Still another object of the present invention may be to provide a thermal management system that will thermally balance the cells while also increasing the thermal mass thus slowing the temperature rise of the battery pack versus prior art systems.

Yet another object of the present invention may be to provide an energy storage system cooling mechanism that is continuously under closed loop control and is capable of intelligently predicting cooling requirements based on rate of discharge versus state of charge.

Still another object of the present invention may be to provide a thermal management system that is capable of reducing the energy storage system cooling demands while driving the vehicle, thus increasing the vehicle range.

Still another object of the present invention may be to avoid condensation inside the energy storage system enclosure by measuring temperature, humidity and calculating a dew point at predetermined intervals.

To achieve the foregoing and other objects a battery pack thermal management system for use in an electric vehicle is disclosed. The system includes a plurality of thermistors attached to a plurality of cells within the battery pack. A battery monitor board is connected to the thermistors. The system also includes a manifold and a plurality of cooling tubes connected to the manifold. The system has a tube seal plug arranged over an end of the cooling tube and an end fitting arranged over an end of the cooling tube.

One advantage of the present invention may be that it provides a novel and improved thermal management system for a battery pack.

Still a further advantage of the present invention may be that it provides a thermal management system for use in an electric vehicle.

Yet another advantage of the present invention may be that it provides a thermal management system for an electric vehicle that will increase the thermal mass of a battery pack, slowing the temperature rise within the battery pack, hence increasing the range and performance of the electric vehicle.

Still another advantage of the present invention may be that it provides a method of maximizing the longevity of the battery pack by thermally managing the cooling and heating of the pack.

Yet another advantage of the present invention may be that it provides a thermal management system that reduces the energy storage system cooling demands while driving the electric vehicle hence increasing the vehicles range.

Yet another advantage of the present invention may be that it provides a thermal management system that will thermally connect each of the cells in the battery pack thereby thermally balancing the entire battery pack while reducing the thermal impedance between the cells of the battery pack.

Yet another advantage of the present invention may be that it provides a way of thermally balancing the cells of the battery pack thus maximizing the longevity, efficiency and power that can be extracted from the energy storage system of the electric vehicle.

Other objects, features and advantages of the present invention will become apparent from the subsequent description and the appended claims, taken in conjunction with the accompanying drawings.

### BRIEF DESCRIPTION OF THE DRAWINGS

FIG. 1 shows a view of a sheet which is a subsystem of an energy storage system (ESS) according to the present invention.

FIG. 2 shows a view of an energy storage system enclosure according to the present invention.

FIG. 3 shows thermistors attached to six different cells of the energy storage system according to the present invention.

FIG. 4 shows a view of a manifold according to the present invention.

FIG. 5 shows a side view of a cooling tube according to the present invention.

FIG. 6 shows an end view of a cooling tube arranged within a tube seal plug according to the present invention.

FIG. 7 shows a side view of a cooling tube according to the present invention.

FIG. 8 shows a top view of a cooling tube inter-engaged with cells of a sheet of an energy storage system according to the present invention.

FIG. 9 shows a view of the end fittings arranged over an end of a cooling tube according to the present invention.

FIG. 10 shows the connection of a manifold and tube seal plug to an ESS enclosure according to the present invention.

FIG. 11 shows the counter flow architecture of the thermal management system according to the present invention.

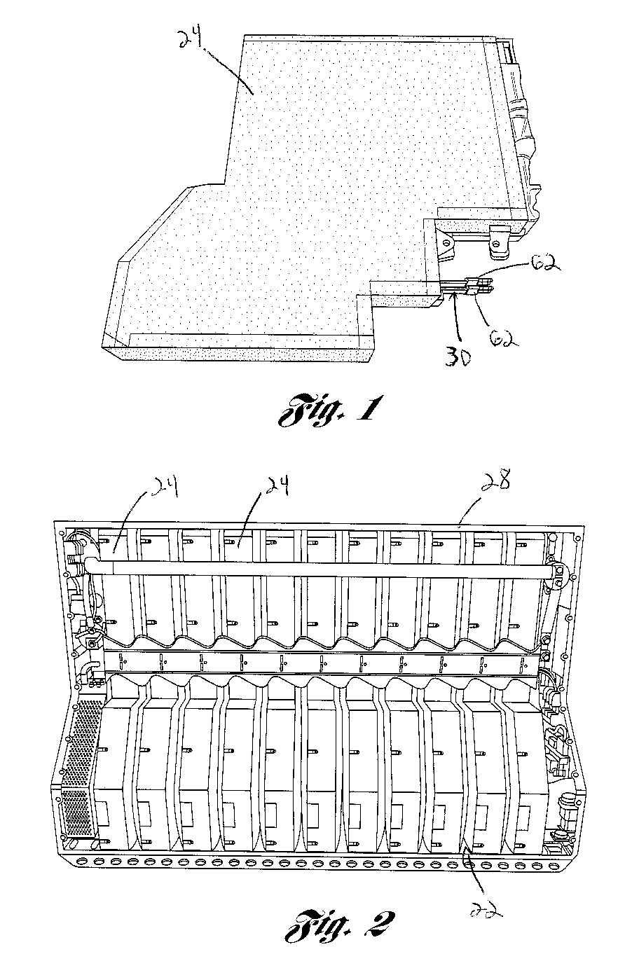

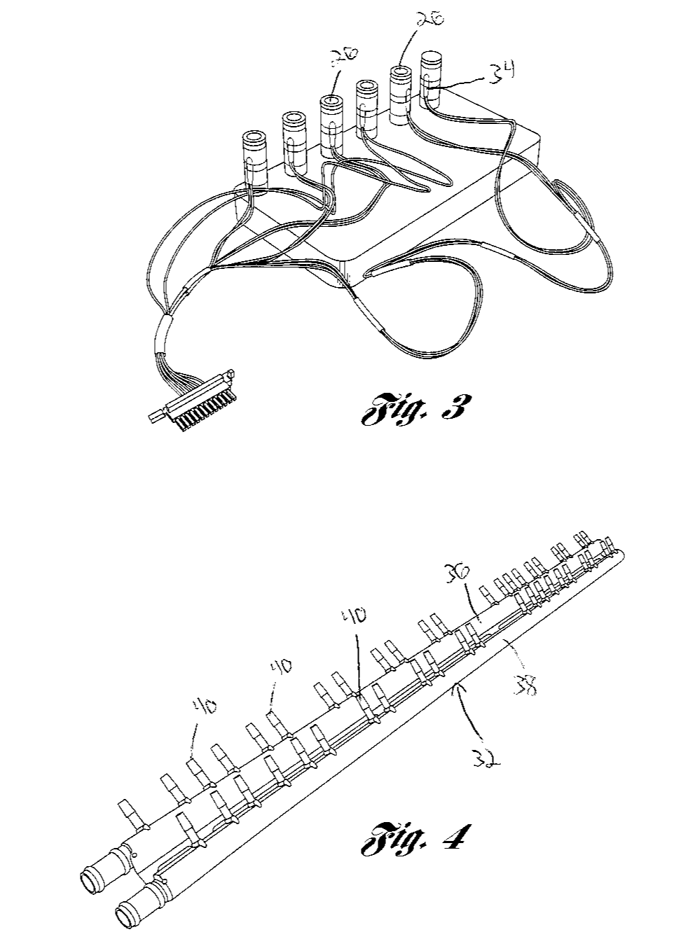

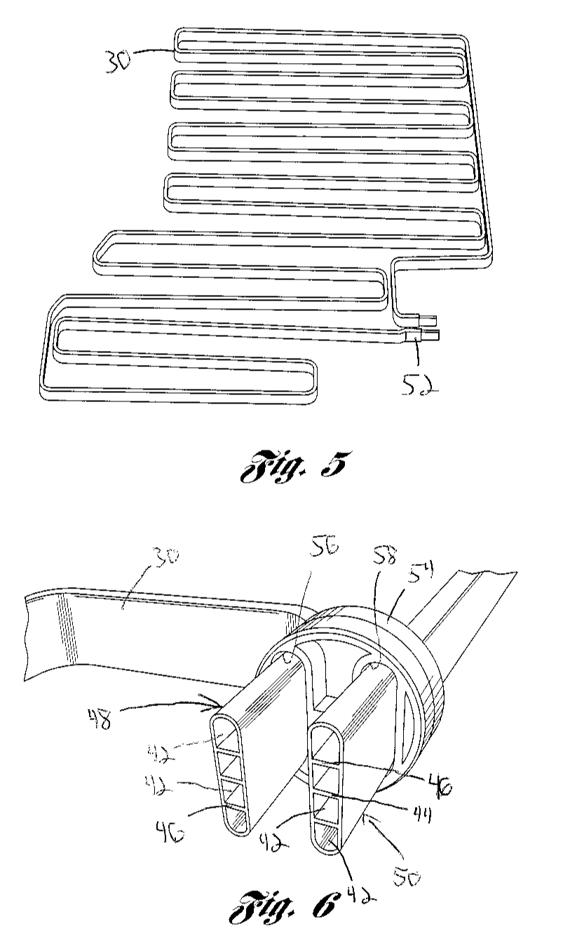

### BRIEF DESCRIPTION OF THE EMBODIMENT(S)

Referring to the drawings, a battery pack thermal management system 20 for use with an energy storage system (ESS) 22 is shown. The energy storage system or battery pack 22 is generally comprised of a predetermined number of battery modules or sheets 24, a main control and logic PSB, and a 12 volt power supply. In one contemplated embodiment the energy storage system 22 will have eleven battery modules or sheets 24, which are capable of producing approximately 375 volts DC. This nominal voltage will operate an electric vehicle that will be capable of traveling many miles without recharging and is capable of delivering enough power and acceleration to compare favorably with or outperform internal combustion engines. In one contemplated embodiment the ESS 22, will be capable of storing enough energy that the electric vehicle can travel approximately 200 miles without recharging. However, it should be noted that it is also contemplated to have an electric vehicle based on the present invention, that can travel well over 200 miles without recharging. It is also contemplated in one embodiment that the electric vehicle using the energy storage system 22 of the present invention will be capable of accelerating from 0 to 60 miles per hour in approximately four seconds. No other electrical car known has produced this type of acceleration and mileage range without recharging.

The present invention may use batteries made of lithium ion cells 26, in particular one embodiment uses commodity 18650 form factor lithium ion cells 26 for the electric vehicle. The battery pack 22 in the present invention stores the chemical energy equivalent of approximately two gallons of gasoline. The battery pack 22 operates at a nominal 375 volts and delivers approximately 240 horsepower to the motor. The energy and power capability of the battery pack 22 allow for the battery pack design and architecture to have many features that ensure the safety of the vehicle and its occupants during use of the electric vehicle. It should be noted that the lithium ion cells 26 are rechargeable such that after recharging, the batteries will be able to provide traction power for the vehicle based a fully recharged and capable battery. The energy storage system 22 in one embodiment comprises 6,831 individual lithium ion 18650 cells 26 that will allow for it to achieve the drive power and range necessary for the vehicle. These cells 26 are electrically connected in parallel groups of 69 cells wherein each of these groups of 69 cells constitutes an electric module called a brick.

The bricks are then connected in series within individual battery modules in the energy storage system 22 called sheets 24. Each sheet or battery module 24 is a single mechanical assembly and consists of nine bricks electrically connected in series. It should be noted that it is contemplated that the sheets 24 will be the smallest replacement unit within the energy storage system 22. Each sheet 24 generally has a nominal voltage of approximately 35 volts DC. Furthermore, each of these sheets 24 contains a mechanical mounting system, battery monitoring hardware electronics, a thermal management system or cooling system 20 according to the present invention as well as various safety systems to ensure proper protection for the vehicle and occupants of such vehicle. In the embodiment contemplated eleven sheets 24 may be used in total to bring approximately 375 nominal volts DC to the energy storage system 22 for use in the electric vehicle. Each of these sheets 24 will be rigidly mounted within an ESS enclosure 28 and electrically connected to one another in series. This series connection will create the nominal voltage of approximately 375 volts DC as described above. It should be noted that the ESS contemplated and shown in the present invention may be adjusted by either increasing or decreasing the number of sheets 24 and/or boards within the ESS 22. The energy storage system 22 may also include a battery monitor board. A battery monitor board is associated with each sheet 24 of the energy storage system 22. The battery monitor board monitors the voltage levels, temperatures and other parameters of all of the bricks within its sheet 24.

Due to the high power output of the energy storage system 22 the individual cells 26 that comprise the ESS 22 must be thermally managed. This arrangement will increase and maximize the longevity of the energy storage system 22. In the present invention the temperature of the cells 26 may be managed at the sheet 24 level wherein each of the cells 26 will benefit equally from the thermal management system 20 regardless of its physical position within the sheet 24. It should be noted that under the thermal management system 20 of the present invention each cell 26 is targeted to be within a temperature range of plus or minus 2° C. within the energy storage system 22. Furthermore, the thermal management system 20 of the present invention may provide for a method of thermally connecting each of the cells 26 in each sheet 24, thereby thermally balancing each sheet 24. Through the balancing of the sheets 24 maximum longevity, efficiency and power will be capable of being extracted from the energy storage system 22. The ESS thermal management system 20 of the present invention removes heat from the energy storage system 22 to provide a cooling or chilling of the cells 26, thus increasing the longevity and range of the electric vehicle on the road. This thermal management system 20 also is capable of adding heat or heating the cells 26 if such heating of the cells 26 is determined to be necessary via a vehicle management system and associated methodologies.

The electric vehicle according to one embodiment of the present invention may have a heating ventilation and air conditioning system (HVAC) comprised of two loops, one for cabin cooling and heating and one for the energy storage system 22 cooling and heating. In one contemplated embodiment these two HVAC systems will be independently controlled. However, it should be noted that it is also contemplated to have both systems controlled by one independent component. The energy storage system 22 may be cooled via its loop by pumping an actively chilled fluid or coolant 72 through a cooling tube 30 which is arranged within each sheet 24 of the energy storage system 22. The temperature of this fluid or coolant will be controlled by the HVAC system. In one embodiment the coolant will be chilled using a refrigerant-to-coolant heat exchanger. However, it should be noted that any other type of heat exchanger may be used depending on the design requirements and the electric vehicle in which the coolant will be used. In one embodiment the refrigerant used may be a tetrafluoroethane, or R134A. However, it should be noted that any other known refrigerant may also be used in the system as described herein. In one embodiment the coolant that will be used will be a 50/50 mix of ethylene or propylene glycol and water. However, any other known coolant may also be used within the thermal management system 20 as described herein. The heat exchanger which may be used in one embodiment of the present invention will be a compact parallel plate heat exchanger wherein the heat is transferred from the coolant to the R134A refrigerant which is driven by the evaporated phase transformation of the refrigerant. In this cooling system 20 the coolant will enter and exit each sheet 24 of the energy storage system 20 via a manifold 32. In one contemplated embodiment a coolant pump will be an integral component of the HVAC system, however it should also be noted that it is contemplated that the coolant pump could also be located and/or controlled separately from the HVAC system according to the present invention. It is also contemplated to have the thermal management system 20 operate via a thermal electric methodology that may use a solid state “Peltier” device such that the thermal management system 20 would eliminate the need for refrigerant and also reduce the noise and vibration of the cooling system 20 for the energy storage system 22. It should also be noted that any other known HVAC system and/or thermal management device that is capable of either removing heat or adding heat to a cell 26 may also be used in the present invention.

The thermal management of the energy storage system 22 according to the present invention is a continuously closed loop control system. In such system the temperature is monitored at a predetermined number of positions in each sheet 24 of the energy storage system 22. In one contemplated embodiment the temperature will be monitored at six positions in each sheet 24. The positions in each sheet 24 will be predetermined prior to insertion into the energy storage enclosure 28. The six positions may be randomly or specifically chosen depending on location of the cells 26 within each sheet 24. To monitor the six temperatures at the six positions within each sheet 24 a predetermined number of temperature monitoring devices 34 will be attached to the predetermined number of cells 26 within each sheet 24. These temperature monitoring devices 34 will then be connected to the battery monitor board for each sheet 24 within the energy storage system 22. In one contemplated embodiment the six temperature measuring devices 34 will be connected to the six different cells 26 within each sheet 24 such that the same six cells 26 in each of the eleven sheets 24 will be monitored within the energy storage system 22 of the present invention. In one contemplated embodiment the temperature monitoring device 34 will be a thermistor 34, however it is also contemplated to use thermocouples or any other temperature measuring device that is capable of being attached directly to a cell 26 to measure a temperature thereon. The temperatures will be transferred from the thermistors 34 via an electrical connection between the thermistors 34 and the battery monitor board. It should be noted that any type of electrical connection such as wire, wireless or any other known transfer technique can be used to transfer the temperature from each monitored cell 26 to the battery monitor board. Each sheet 24 within the energy storage system 22 has an individual battery monitor board related thereto. Each of these battery monitor boards, will report the temperatures of the six cells 26 within their sheet 24 along with other data to a battery safety monitor. The battery safety monitor will transfer these temperatures along with the other data to a vehicle management system.

The vehicle management system has overall control of the vehicle management and associated operating components. The continuous communication between the vehicle management system and the battery safety monitor will allow for an HVAC control board to determine the energy storage system 22 cooling requirements on a continuous basis. One contemplated control algorithm for the vehicle management system will be capable of intelligently predicting the cooling requirements based on the rate of discharge of a cell 26 versus the state of charge of the cells 26 within each sheet 24. In one contemplated methodology if the energy storage system 22 reaches a zero state of charge before a maximum allowable operation temperature is reached then the vehicle management system would send a command and signal to not cool the energy storage system 22. Also the control algorithm and the vehicle management system may be capable of reducing the parasitic power loss of cooling while the vehicle is driving by having the energy storage system 22 precooled during charging and at any time that the vehicle is connected to an AC power source. This reduction of the energy storage system 22 cooling demands while driving will result in the vehicle range being increased by a predetermined percentage. Furthermore, the vehicle management system may be capable of monitoring and avoiding condensation inside the ESS enclosure 28 when the cooling of the energy storage system 22 is occurring via the thermal management system 20. By measuring the temperature, humidity and calculating a dew point within the energy storage system enclosure 28, a minimum cooling temperature for the energy storage system 22 may be maintained above a temperature where condensation becomes a risk. It should also be noted that another methodology to monitor and reduce condensation is also contemplated in the thermal management system 20 according to the present invention. This methodology uses a cold plate located within the energy storage system enclosure 28 to force condensation to occur at a predetermined location within the enclosure 28 thus having the resulting liquid safely controlled and removed from the enclosure 28. It is also contemplated that the thermal management system 20 of the present invention may reduce the cooling demand and hence the required energy needed by having the energy storage system enclosure 28 insulated which would help to reduce elevated ambient temperatures and hence condensation within the energy storage system enclosure 28. These contemplated methodologies along with other contemplated methodologies are all controlled by the vehicle management system to intelligently predict cooling or heating needs of the energy storage system 22 and when such cooling should occur to provide for the most efficient use of the HVAC system and the most efficient use and increased longevity of the energy storage system cells 26.

The thermal management system 20 also includes a manifold 32 that is fastened to an exterior surface of the ESS enclosure 28. The manifold 32 may be fastened by any known technique such as a fastener, any mechanical fastening technique, any chemical fastening technique such as gluing, epoxy, welding, or the like. The manifold 32 generally is a double barreled or double cylinder extrusion. In one preferred embodiment the extrusion is made from an aluminum material. However, it should be noted that any other metal, ceramic, plastic, composite, natural material or the like may be used for the manifold 32. The two cylinder manifold 32 will have one of the cylinders 36 connected to the coolant pump on one end thereof, which is the input side for the thermal management system 20 of the energy storage system 22. This input cylinder 36 of the manifold 32 will feed or pass the coolant from the coolant pump into the cooling tube 30 of each sheet 24 of the energy storage system 22. The second barrel or cylinder 38 of the manifold 32 is the output side of the thermal management system 20. After the coolant circulates through each cooling tube 30 arranged in each sheet 24 it will return via the second cylinder 38 to the HVAC system loop for rechilling and recirculation within the ESS cooling system. The manifold 32 also may help the energy storage system 22 maintain equal flow and hence uniform temperature control within and among the plurality of cooling tubes 30 through symmetry of pressure gradients across the coolant flow path within the ESS cooling system 20. Each of the cooling tubes 30 will have a predetermined length and cross section geometry that will be the same for each of the cooling tubes 30. This will allow for the balance of the system 20 to be achieved through the design of the manifold 32 such that it will distribute the coolant evenly among the cooling tubes 30. The cylinders 36, 38 of the manifold 32 may be designed such that they have a diameter and length that are large enough to ensure that the pressure drop is much smaller than the pressure drop through a cooling tube 30. This pressure drop which is inversely proportional to the flow through any of the given coolant paths within the energy storage system 22 will then approximately be equal to the pressure drop through one of the cooling tubes 30. It is also contemplated in one embodiment to completely remove the effects of the pressure drop of the manifold cylinders 36, 38 from the system 20 by having the inlet and outlet points of the coolant located at opposite ends of the manifold 32. This will ensure that each coolant path has a pressure drop of one full cylinder length in addition to the pressure drop of the cooling tube 30. It is also contemplated in another embodiment that the manifold 32 may be designed with progressively sized orifices to compensate for any pressure drop along the manifold 32. The manifold 32 of the present invention may include a plurality of nozzles or flow members 40 extending from a surface thereof. The nozzles 40 may be used to move the fluid or coolant 72 from the manifold 32 to the cooling tubes 30 and back to the HVAC system. Also in another contemplated embodiment the ESS cooling system 20 may have a sacrificial anode arranged in the manifold 32 to reduce corrosion within the system 20. The addition of this component would only require an orifice to be placed at a predetermined position in the manifold 32 and a metal or other material that is more readily corrodible than aluminum to be attached thereto. This material would then corrode before the aluminum components in the thermal management system 20 and hence would be replaced before it dissolves completely thus ensuring the aluminum components of the system would not corrode.

The thermal management system 20 of the present invention also may include a cooling tube 30 arranged within each sheet 24 of the energy storage system 22. In one contemplated embodiment the cooling tube 30 will be an extruded aluminum tube, however, it should be noted that any other type of metal, ceramic, plastic, composite, natural material or the like that is capable of extrusion casting or machining may also be used for the cooling tube 30 and all other components in the system 20. It should also be noted that the cooling tube 30 must be thermally conductive. The cooling tube 30 of the present invention may be bent into a predetermined specific shape. One contemplated predetermined shape is shown in FIG. 5. This shape of the present invention includes a predetermined number of bends and corners therein. It should be noted that the shape can be of any random shape or any known shape depending on the positioning of the cells 26 within each sheet 24 of the energy storage system 22. Therefore, any known shape or random shape may be used to form the cooling tube 30 for insertion into an energy storage system sheet 24. It should be noted that an aluminum material for the cooling tube 30 was chosen for its resistance to elevated temperatures, its thermal conductivity, its light weight and its malleability which will allow for the bending process to be made in a manufacturing setting without increased costs. In one contemplated embodiment the specific aluminum alloy used was a 6063 alloy. The 6063 alloy generally is a commonly extruded alloy. It should be noted that the cooling tube 30 of the present invention has a predetermined wall thickness that will allow for the thinnest wall possible thus reducing the weight of the final assembly, increasing the thermal conductivity of the cooling tube 30 and allowing for consistent bending of the cooling tube 30 during the entire manufacturing process. It should be noted that the final shape of the bent cooling tube 30 may have the two ends of the cooling tube 30 arranged adjacent to each other, however, any other final shape may also be used. It should be noted that a predetermined distance will separate the ends of the cooling tube 30 such that a connection of the cooling tube 30 to the manifold 32 may be easier for the manufacturer of the electric vehicle.

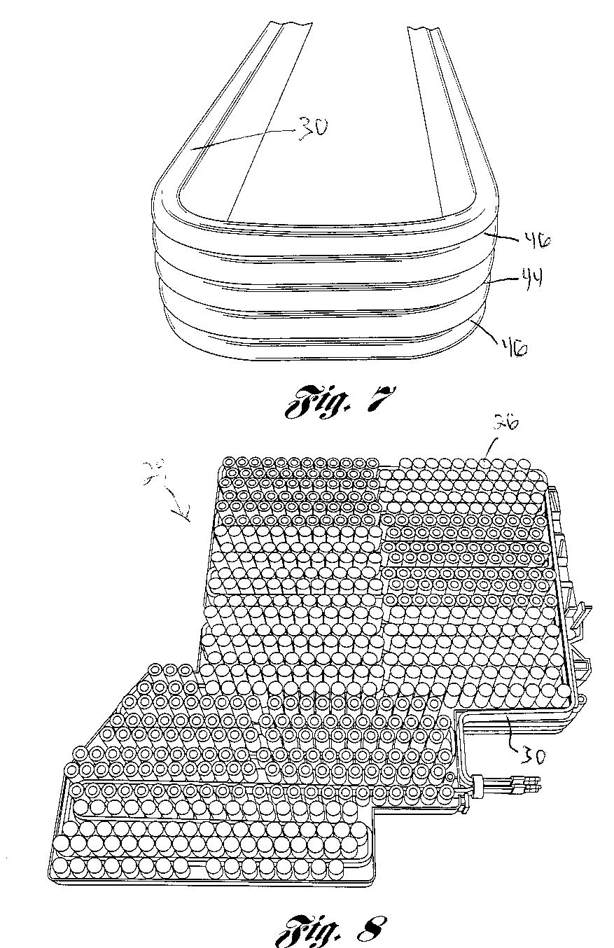

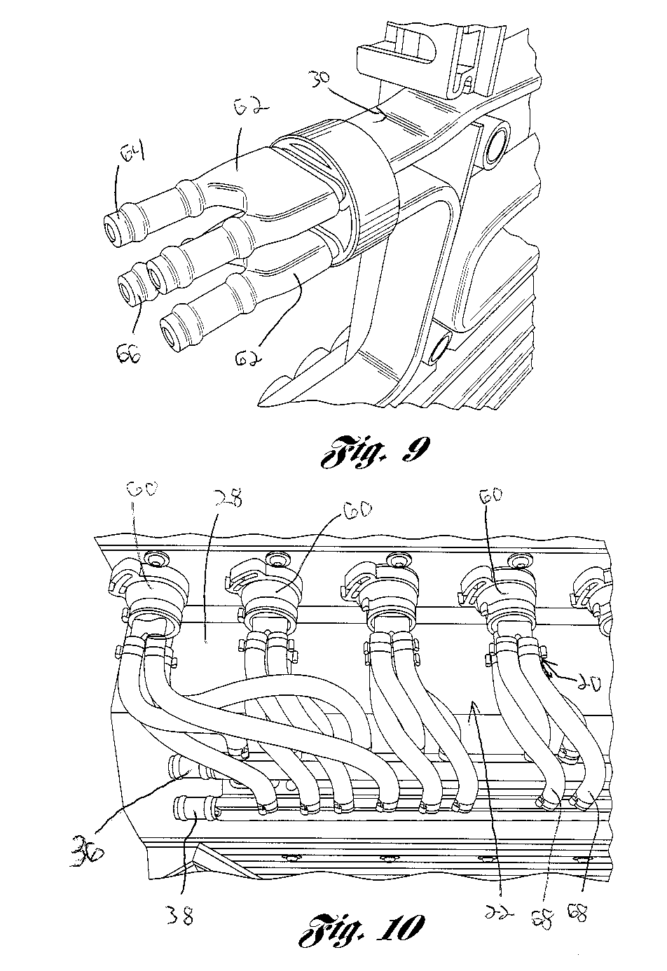

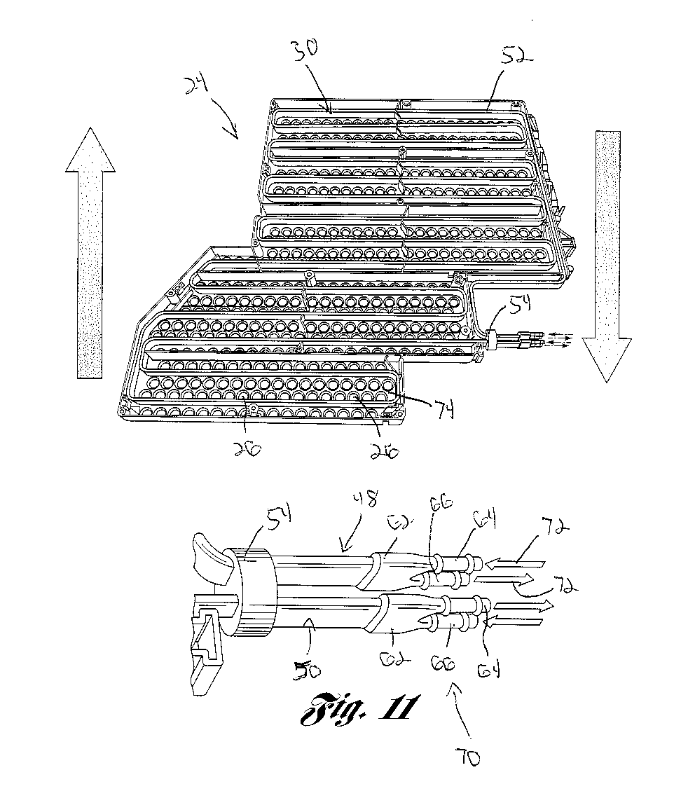

The cooling tube 30 in its extruded state will include a plurality of individual channels or lumens 42 arranged in an inner bore thereof. In one contemplated embodiment there is four individual channels 42 arranged along the entire length of the cooling tube 30. It should be noted that the fluid or coolant delivery requirements of the cooling tube 30 according to the present invention only requires two such channels, however the additional two channels may be added to the cooling tube 30 to take advantage of the resulting two rib feature described hereafter. The cooling tube 30 may include two different types of ribs that will allow for the extruded cooling tube 30 to be formed into the required geometry by supporting the channels 42 during the bending process. It should be noted that generally to bend a two channel ribless tube it generally is necessary to fill the tube with sand, glass, beads, or some similar type of material to prevent the channels from collapsing during the bending process. It should also be noted that collapsing a channel 42 within the cooling tube 30 would render the cooling tube 30 useless for fluid and coolant transfer, hence destroying the effectiveness of the thermal management system 20 for the energy storage system 22. Therefore, the ribs will enhance and create a sustainable manufacturing process for the energy storage system 22 and thermal management for the electric vehicle as described herein. The two rib system will include at least one dividing rib 44 and at least one supporting rib 46 arranged within the interior bore of the cooling tube 30. In the contemplated embodiment shown in FIGS. 6 and 7 the dividing rib 44 will be arranged generally at or near a mid point of the cross section of the cooling tube 30. A first supporting rib 46 in the contemplated embodiment shown in FIGS. 6 and 7 may be arranged approximately half way between a side of the cooling tube 30 and the dividing rib 44. Also, a second supporting rib 46 may be arranged at approximately a half way point between the dividing rib 44 and the opposite side of the cooling tube 30. This will create a four channel 42 cooling tube 30 wherein the channels 42 run or extend the entire length of the cooling tube 30 from a first end 48 to the second end 50 of the cooling tube 30. It should be noted that it is contemplated to use any other type of configuration and number of channels within the cooling tube 30 including but not limited to two channels, three channels, five channels, six channels, seven channels, eight channels, etc. The use of the four channels 42 and hence three ribs will reduce the manufacturing costs by reducing the need to fill the tube 30 during the bending process into the predetermined bent shape.

After the cooling tube 30 has been bent into its predetermined shape the cooling tube 30 must be electrically isolated from the cells 26. It should be noted that a thermally conductive frame or grid is also contemplated to be used in another embodiment to hold the cells 26. It should be noted that to maximize the cooling potential of the thermal management system 20 the cell 26 layout and the sheet 24 have to be designed such that each cell 26 will be located close or very close to the cooling tube 30 within the sheet 24. With the cooling tube 30 passing closely by each of the cells 26, and with each of the cells 26 generally being at a different electric potential, electric isolation is necessary and important to the thermal management system 20. Generally, to achieve this electrical isolation the present invention will have the cooling tube 30 coated with a material that will provide a continuous dielectric coating 52. It should be noted that the electrically insulating coating 52 may only cover a portion of the cooling tube 30. The uncoated portion may be submerged in the potting compound 74. In one contemplated embodiment an electrical epoxy resin such as a 3M Scotchcast 5230N is used as the coating. However, it should be noted that any other type of coating capable of providing electric isolation for the cells 26 may also be used in the present invention. After the coating 52 is applied and dried the entire surface of the cooling tube 30 may be subjected to a hi pot test from approximately 2600 volts DC or 1835 volts AC to verify the electrical isolation of the cooling tube 30.

After the cooling tube 30 is completely coated and tested for its electrical isolation the two adjacent ends 48, 50 of the cooling tube 30 will be arranged within a tube seal plug 54. The tube seal plug 54 generally has a cylindrical shape with a first and second orifice 56, 58 that generally matches the outer surface of the cooling tube 30. In the embodiment shown the orifices 56, 58 generally have an oval shape to match or mimic the overall oval shaped cross section of the cooling tube 30 according to the present invention. It should be noted that any other shaped cooling tubes 30 and orifices in the tube seal plug 54 may be used depending on the design requirements for the thermal management system 20. Generally, the tube seal plug 54 may be made of any type of plastic. In one contemplated embodiment the tube seal plug 54 is made from a glass filled injection molded plastic. However, it should be noted that any other metal, ceramic, plastic, composite, or natural material may also be used for the tube seal plug 54. It should also be noted that extruded cast or machined components may also be used for the tube seal plug 54, cooling tube 30 or any other of the components of the thermal management system 20 according to the present invention. The two ends 48, 50 of the cooling tube 30 may be secured to the tube seal plug 54 via any known bonding technique, i.e., a mechanical bond or a chemical bond. In one contemplated embodiment an epoxy adhesive will be used to secure the tube seal plug 54 to the two ends 48, 50 of the cooling tube 30. However, any other mechanical or chemical fastening technique may also be used. With the cooling tube 30 generally having curved surfaces and an irregular geometry the tube seal plug 54 creates a uniform surface on which to seal the ESS enclosure 28 at the point where the cooling tube 30 exits the ESS enclosure 28. This seal will be achieved using a tube seal boot 60 which will be clamped onto the tube seal plug 54 and a predetermined surface of the ESS enclosure 28 via any known fastener. In one contemplated embodiment the tube seal boot 60 is made of a rubber material, however any other soft plastic, composite, natural material, etc., may be used for the tube seal boot 60. It should be noted that any general circular clamp may be used to secure the tube seal boot 60 to the tube seal plug 54 and enclosure 28, however any other fastening technique may also be used including but not limited to, chemical bonding techniques and any other mechanical fastening technique. Applicant has two prior pending U.S. applications relating to cooling tubes and cooling batteries or cells, having application Ser. Nos. 11/129,118 and 11/820,008 which are hereby incorporated by reference.

An end fitting 62 may be arranged over each end 48, 50 of the cooling tube 30 after it is arranged within the tube seal plug 54. The end fitting 62 generally has a first and second nipple 64, 66 that extends from one end thereof. These nipples 64, 66 allow for hoses 68 to be attached between the cooling tubes 30 and the nozzles 40 of the manifolds 32. It should be noted that nozzles 40 of the manifold 32 may be designed with any known configuration to allow for a predetermined flow therethrough and into the cooling tubes 30 of the ESS cooling system 20. Hence, an end fitting 62 may be placed on each end 48, 50 of the cooling tube 30 such that two nipples 64, 66 terminate from each end of the cooling tube 30. It should be noted that the nipples 64, 66 may include a plurality of beads thereon to improve hose 68 retention thereto. However, any other method of improving hose retention to the nipples 64, 66 may be used including but not limited to chemical bonding techniques or any other known mechanical fastening technique.

The end fitting 62 is arranged over each end 48, 50 of the four channel cooling tube 30 such that the two nipple end fitting 62 has two adjacent channel 42 pairs combined and aligned into one isolated fluid path within the cooling tube 30 effectively yielding a two channel cooling tube 30 therein. Therefore, with an adjacent pair of channels 42 feeding and flowing into one nipple 64 on the end fitting 62, a resulting increase flow of the coolant increases the heat transfer and efficiency of the thermal management system 20 for the energy storage system 22. It should be noted that after the securing of the end fittings 62 and tube seal plug 54 to the cooling tube 30 it is contemplated to have the cooling tube assembly leak tested to a predetermined pressure using compressed air. However, any other known leak testing technique may also be used. It should further be noted that one advantage of the present invention is that all fluid connections between the manifold 32 and the sheets 24 will be made outside of the ESS enclosure 28 thus preventing any potential leak points from contaminating the cells 26 and other electrical components arranged within the enclosure 28 by leaks of coolant within the energy storage system 22. Hence, after leak testing any leaks that may occur will occur on the outer surface of the enclosure 28 thus reducing any catastrophic failures of the sheets 24 within the energy storage system 22 and hence reducing costs to the manufacturer and users of the electric vehicle.

The thermal management system 20 of the present invention achieves uniform cooling of the sheet 24 via a counter flow architecture 70 of the coolant flowing through the sheet 24 of the energy storage system 22. Without the use of this counter flow architecture the cells 26 located closer to the input side of the cooling tube 30 may benefit most from the heat transfer while those cells 26 located farther away would have a reduced benefit or may be no benefit at all. Generally, in one prior art heat transfer systems simply pumping coolant into one side of a cooling tube and out the other side would not suffice to provide a uniform cooling throughout the entire system. However, the thermal management system 20 of the present invention uses the counter flow architecture to pump coolant into only one of the nipples 64 of the end fitting 62 on one end 48 of the cooling tube 30 and into the opposite nipple 66 of the end fitting 62 on the other end 50 of the cooling tube 30. The coolant 72 would then exit the sheet 24 via the remaining two nipples on the end fittings 62. This will ensure that uniform cooling will occur throughout the sheet 24 as the coolant 72 will be flowing in opposite directions within the cooling tube 30 via the channels 42 arranged therein. By connecting the manifold 32 as described, the use of the counter flow of the coolant 72 through the sheet 24 ensures that uniform cooling occurs throughout all of the cells 26 within the predetermined shaped sheet 24 of cells within the energy storage system 22. It should be noted that in another contemplated embodiment the counter flow architecture may also be achieved by designing a predetermined end fitting that would cover both ends of the coolant tube 30 but would also allow for the cross counter flow architecture of the coolant flowing through the cooling tube 30. The complexity of the end fitting 62 would be increased in such an alternate embodiment but it would also eliminate two coolant hose connections and thus four possible leak points per sheet 24 on the outer surface of the energy storage system enclosure 28.

It should be noted that battery or cell life is prolonged at lower temperatures than those at higher temperatures. The HVAC system of the present invention may be used to keep the cells cool. However, it should be noted that power is required to run the HVAC system and that the driving range can be improved by minimizing the usage of the HVAC system in the present invention while driving. Therefore, it is contemplated that just before usage of the electric vehicle the HVAC system would be turned on and run a predetermined time using electricity from a typical power grid or the like. The use of the HVAC system before usage of the electric vehicle will effectively precool the batteries or cells 26 of the ESS thus leading to longer battery life and increased driving range for the electric vehicle. It should further be noted that the vehicle management system will not allow any charging of the cells below 0° C. Therefore, a first command may have to be given by the vehicle management system to slowly heat the cells to reach a 0° C. temperature upon which charging may then begin of the battery pack. Furthermore, it should be noted that the vehicle management system will not allow use of the battery pack or electric vehicle below −20° C., however it should be noted that the electronics are still maintained at this temperature because the battery discharge can continue down to approximately −30° C. It should be noted that the temperature ranges given here are for just one contemplated embodiment and that any known temperature range may be used for the present invention. The electric vehicle is capable of driving when the battery pack is in the range of −20° C. to 0° C., however charging cannot occur until the battery pack is heated to 0° C. Between 0° C. and approximately 45° C. charging of the battery pack and driving of the electric vehicle is permitted by the vehicle management system. Between 45° C. and approximately 55° C. power will be limited during charging and driving of the electric vehicle. At approximately 55° C. and higher no operation will be permitted for the electric vehicle and battery pack because of the high temperature and risk of mitigation propagation or thermal runaway events therein. It should also be noted that based on the temperature ranges given above, which are all estimated and used in one contemplated embodiment, the due point and humidity within the ESS will also be monitored to ensure dew does not form in the energy storage system or within the electric vehicle interior. It should be noted that any time frame can be used to begin the precooling with the HVAC system for the electric vehicle. In one contemplated embodiment thirty minutes before departure or usage of the vehicle such cooling may occur. However, it should be noted that any time frame from a few seconds to multiple minutes or hours may be used to effectively precool the battery pack and cells of the energy storage system according to the present invention. It should also be noted that all sensors associated with the ESS including but not limited to, temperature sensors, humidity sensors, voltage sensors, smoke sensors, inertia sensors, moisture sensors, and the like will be checked to ensure that appropriate conditions exist to either charge or use the battery pack for the electric vehicle of the present invention.

During assembly of the thermal management system 20, a hose 68 or any other connecting member is placed on one nipple 64, 68 of an end fitting 62 of the cooling tube 30 on one end thereof and the input cylinder 36 of the manifold 32. The second input hose 68 would be arranged between the opposite nipple 64, 66 on the other end fitting 62 on the opposite end of the cooling tube 30 and a nozzle 40 on the input side of the manifold 32. The remaining nipples would be connected via a hose 68 or any other connecting member to the output side of the manifold 32 thus returning the coolant to the HVAC system for recooling and other manufacturing techniques thereon.

During assembly of the energy storage system 22 the cooling tube 30 and cells 26 may be assembled into a lower clamshell where thermal contact must be made between the cooling tube 30 and the cells 26. The placement of the coolant tubes 30 next to the cells 26 may not be adequate because only line contact may be formed, thus thermal impedance may be very high within such a set up. Therefore, the present invention may increase surface contact between the cylindrical cell 26 and the generally flat cooling tube 30. In one contemplated embodiment of the present invention a thermally conductive yet electrically isolative material 74 may be arranged between the cooling tubes 30 and the cells 26. In one contemplated embodiment this material may be a two component epoxy encapsulant, such as Stycast 2850/ct or any other potting compound. However, any other thermally conductive yet electrically insulative material 74 may also be used. This potting compound will thermally connect each cell 26 of the sheet 24 to the cooling tube 30. With this thermal connection heat will be transferred from the cell 26 casing to the cooling tube 30 and then from the cooling tube 30 to the circulating coolant 72. Depending on the environmental conditions of the energy storage system 22 this heat transfer may also function in the reverse direction. In particular, the cells 26 and hence the energy storage system 22, may be heated as well as cooled if necessary as determined by the vehicle management system. This heat may be generated either by an external electric heater or by reverse cycling the HVAC system which is contemplated for use in the electric vehicle. It should be noted that by thermally connecting each cell 26 to the cooling tube 30 the thermal impedance between the cells 26 may also be reduced. As a result, the cells 26 may benefit from thermal balancing even when the HVAC system is idle. Also, it should be noted that another advantage of the design of the present thermal management system 20 may be that the thermal mass of the energy storage system 22 may be increased by the overall effect of the potting compound 74, the cooling tubes 30 and the coolant 72 compared to a prior art air cooled system. This increase in thermal mass may slow any temperature rise of the energy storage system 22 compared to any of the prior art air cooled systems. It should be noted that in other contemplated embodiments a thermally conductive foam, paste, etc., may also be used in place of the potting compound. Furthermore, it is also contemplated that to help reduce the weight of the energy storage system 22 and hence electric car, thus increasing its range, micro spheres or other lightweight fillers may be added to the potting compound or other material thus reducing the overall weight of the electric vehicle. It should also be noted that the cooling tube 30 may be made of a compliant material and pressed into place between the cells 26 or may even include other features on its outer surface that will increase the surface contact area with the cells 26 within the energy storage system 22. It should also be noted that the cooling tube 30 may be scalloped in such a way that surface contact between the cell casing and cooling tube 30 is increased, thereby improving heat transfer. It should be further noted that such scalloping allows for a more dense packaging of cells 26 thereby reducing the size of the sheet 24.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

What is claimed is:

1. A battery pack thermal management system, said system including:
a manifold;
a plurality of temperature monitoring devices attached to a plurality of cells of the battery packs;
a battery monitor board connected to said temperature monitoring devices;
a plurality of cooling tubes connected to said manifold;
a tube seal plug arranged over an end of said cooling tube; and
an end fitting arranged on said end of said cooling tube.

2. The system of claim 1 wherein said manifold having a first and second cylinder arranged adjacent to one another, said first cylinder is an input side and said second cylinder is an output side.

3. The system of claim 2 wherein said cylinders are made of an extruded aluminum material.

4. The system of claim 1 wherein said cooling tubes are an extruded aluminum material bent into a predetermined shape, said bent shape results in both ends of said cooling tube being adjacent to one another.

5. The system of claim 4 wherein both ends of said cooling tube are arranged within said tube seal plug.

6. The system of claim 1 wherein said cooling tube having four channels therein.

7. The system of claim 1 wherein said cooling tube having at least one dividing rib and at least one supporting rib.

8. The system of claim 7 wherein said dividing rib arranged at an approximate mid point of said cooling tube and a first supporting rib arranged between said dividing rib and a side surface of said cooling tube and a second supporting rib arranged between said dividing rib and another side surface of said cooling tube.

9. The system of claim 1 wherein said cooling tube is electronically isolated from said cells.

10. The system of claim 1 wherein said cooling tube is coated with a dielectric material.

11. The system of claim 10 wherein said dielectric material is an epoxy resin.

12. The system of claim 1 further including a tube seal boot secured to said tube seal plug.

13. The system of claim 1 wherein said end fitting having a first and second nipple extending from an end thereof.

14. The system of claim 13 wherein a counter flow architecture is used through said cooling tubes.

15. The system of claim 14 wherein said counter flow architecture has coolant pumped into one of the nipples on one end of said cooling tube and into an opposite nipple on the other end of said cooling tube.

16. The system of claim 15 wherein said coolant leaves said cooling tube via said other two nipples.

17. The system of claim 1 wherein said cells and said cooling tube are thermally connected to each other with a thermally conductive and electronically insulative material.

18. The system of claim 17 wherein said material is a potting compound epoxy, foam or paste.

19. A thermal management system for use with an energy storage system in an electric vehicle, the energy storage system having a plurality of cells arranged into a plurality of sheets, wherein the sheets are housed inside an ESS enclosure, said thermal management system including:
a coolant thermally controlled by an HVAC system;
a temperature monitoring device attached to a predetermined cell in each sheet;
a battery monitor board connected to said temperature monitoring device;
a manifold secured to an exterior surface of the ESS enclosure;
a cooling tube arranged within each sheet, said cooling tube connected to said manifold;
a tube seal plug arranged over both ends of said cooling tube; and
an end fitting arranged on each end of said cooling tube.

20. The system of claim 19 wherein said manifold including a first and second cylinder, said cylinders having a plurality of nozzle members extending from a surface, said first cylinder is an input side and said second cylinder is an output side of the system.

21. The system of claim 19 wherein said manifold is an aluminum material.

22. The system of claim 20 wherein said cylinders having a predetermined diameter to distribute said coolant evenly among all of said cooling tubes.

23. The system of claim 19 wherein said cooling tubes are an extruded material bent into a predetermined shape that allows for said cells to be in thermal contact with said cooling tubes, said bent shape having said ends of said cooling tube adjacent to one another.

24. The system of claim 19 wherein said cooling tube having a plurality of channels therein.

25. The system of claim 24 wherein said cooling tube having at least one dividing rib and at least one supporting rib.

26. The system of claim 19 wherein said cooling tube is coated with a material to electronically isolate said cooling tube from said cells.

27. The system of claim 26 wherein said material is an epoxy resin that provides a continuous dielectric coating.

28. The system of claim 19 further including a tube seal boot secured to said tube seal plug and a surface of the ESS enclosure.

29. The system of claim 24 wherein said end fittings having a first and second nipple extending from an end thereof.

30. The system of claim 29 wherein the thermal management system uses a counter flow architecture through said cooling tube.

31. The system of claim 27 further including a hose arranged between said end fitting and said manifold, said manifold connected to said HVAC system to provide a path for said coolant to travel in a closed loop cooling or heating system.

32. The system of claim 30 wherein a pair of adjacent said channels in said cooling tube are in communication with one of said nipples of said end fitting.

33. The system of claim 32 wherein said counter flow architecture has said coolant pumped into one of said nipples on one end of said cooling tube and into an opposite nipple on the other end of said cooling tube.

34. The system of claim 33 wherein said coolant leaves said cooling tube via said two other remaining nipples.

35. The system of claim 23 wherein said thermal contact occurs via a thermally conductive and electrically insulative material.

36. The system of claim 35 wherein said material is an epoxy, foam or paste.

37. The system of claim 35 wherein said thermal connection of said cells to said cooling tube reduces thermal impedance between said cells and a thermal mass of said energy storage system is increased thus slowing any temperature rise therein.

38. The system of claim 19 wherein said HVAC system is operated prior to use of the electric vehicle to precool the cells to a predetermined temperature.

39. A method of controlling the temperature of a battery pack in an electric vehicle, said method including the steps of:
installing a predetermined number of thermistors on a predetermined number of cells of the battery pack;
installing a cooling tube in the battery pack to provide for a thermal connection between said cells and said cooling tube; and
moving a coolant through said cooling tube in a counter flow architecture to provide a uniform cooling over the entire battery pack.
